(19) United States
(12) Patent Application Publication
(10) Pub. No.: US 2013/0250383 A1
(43) Pub. Date: Sep. 26, 2013

(54) Apparatus for multi-wavelength holographic imaging

(71) Applicants: Michael Mater, Chelsea, MI (US); Richard Wineland, Chelsea, MI (US)

(72) Inventors: Michael Mater, Chelsea, MI (US); Richard Wineland, Chelsea, MI (US)

(73) Assignee: Coherix, Inc., Ann Arbor, MI (US)

(21) Appl. No.: 13/425,586

(22) Filed: Mar. 21, 2012

(51) Int. Cl. G03H 1/22; B82Y 20/00

(52) U.S. Cl. 359/32; 977/902

(57) ABSTRACT

A multiwavelength holographic imaging apparatus uses a frequency converter for converting input tunable coherent light having a wavelength tunable around a wavelength λ₂ to tunable output coherent light having a wavelength tunable around a wavelength λ₁, wherein the image receiver receiving the holographic image is sensitive to the light of wavelength λ₁. The image receiver may not be sensitive to light of wavelength λ₂, for example if λ₂ is in the infrared spectral region greater than 1.3 microns.

### FIELD OF THE INVENTION

The field of the invention is the field of measuring surface topography of an object.

### BACKGROUND OF THE INVENTION

Interferometry has been used for over a century to measure the surface topography of objects, typically optical components, and distances and small changes in such distances. With the advent of lasers having long coherence lengths and high brightness, the field has expanded greatly. Interferometric imaging, as depicted by FIG. 1, has been difficult to implement for objects with surfaces with steps or slopes greater than a half wavelength of light per resolution element of the imaging system, because the phase count is lost, and the height of the surface is known only modulo λ/2, where λ is the wavelength of light used for the interferometer.

If a series of interferograms are recorded with different wavelengths λ₁, the ambiguity in the phase may be resolved, and the heights on the object surface relative to a particular location on the particle surface may be calculated, as is shown in the patents cited below.

U.S. Pat. Nos. 5,907,404 and 5,926,277, assigned to the assignee of the present invention, show that a number of such interferograms taken with various phase delays in the reference beam and various wavelengths of the light source 10 may be recorded and computer analyzed to construct a “synthetic interferogram”, which is an interferogram that one would measure if one had a light source of much different wavelength from the wavelengths from the light source 10. Thus, the “lines” on the interferogram could show height differences of, say, 100 microns instead of 0.4 micron height differences, so the lines would be much further apart and much easier to keep track of. Lasers of 200 micron wavelength are hard to find, and electronic imaging equipment for such wavelengths is even harder to find, and spatial resolution of such a detector, if available, could not possibly match the resolution of detectors for visible and near infra-red light.

### RELATED PATENTS AND APPLICATIONS

U.S. Pat. No. 5,907,404 by Marron, et al. entitled “Multiple wavelength image plane interferometry” issued May 25, 1999.

U.S. Pat. No. 5,926,277 by Marron, et al. Method and apparatus for three-dimensional imaging using laser illumination interferometry” issued Jul. 20, 1999.

U.S. Pat. No. 7,317,541 by Mater entitled “Interferometry method based on the wavelength drift of an illumination source” issued Jan. 8, 2008.

U.S. Pat. No. 7,359,065 by Nisper, et al. entitled “Method of combining holograms” issued Apr. 15, 2008.

U.S. Pat. No. 7,440,114 by Klooster , et al. entitled “Off-axis paraboloid interferometric mirror with off focus illumination” issued Oct. 21, 2008.

U.S. Pat. No. 7,456,976 by Mater entitled “Statistical method of generating a synthetic hologram from measured data” issued Nov. 25, 2008.

The above identified patents and patent applications are assigned to the assignee of the present invention and are incorporated herein by reference in their entirety including incorporated material.

### OBJECTS OF THE INVENTION

It is an object of the invention to introduce a novel multiwavelength coherent interferometric imaging system using relatively inexpensive lasers which are commercially available and which can switch wavelengths in a very short time.

### SUMMARY OF THE INVENTION

Commercially available diode lasers used for communication are relatively inexpensive, reliable, tunable over a relative large spectral region, and can switch frequencies rapidly. The lasers which typically are in the wavelength regions of 1300 and 1550 nanometers (nm) can, unfortunately, not be imaged using high quality silicon CCD and CMOS image receivers. In addition, light in the infra-red (IR) spectral region can give as high resolution images as light in the visible and near IR region. The present invention uses a frequency converter to convert the light from such communication lasers to visible or near IR light in the wavelength regions around 650 and 775 nm which can be used in a multiwavelength interferometric imaging system to measure surface topography of objects.

### BRIEF DESCRIPTION OF THE DRAWINGS

FIG. 1 is a sketch of an interferometric imaging system.

FIG. 2 is a sketch of the tunable light source for the interferometric imaging system of the invention.

FIG. 3 is a sketch of the most preferred frequency converter of the invention.

FIG. 4 is graph of the power output the most preferred frequency converter of the invention.

### DETAILED DESCRIPTION OF THE INVENTION

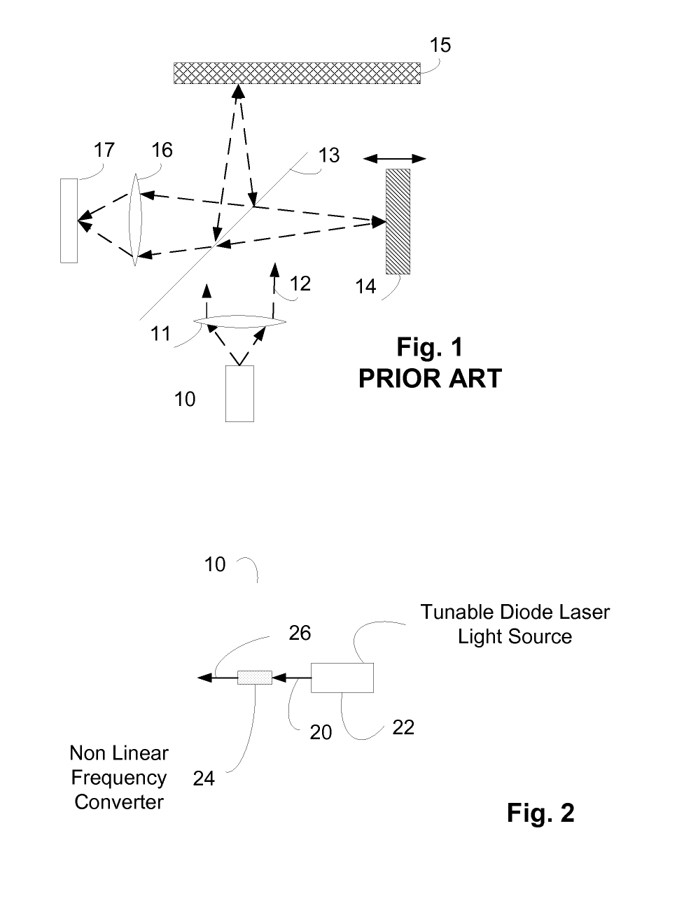

A number of n measurements for synthetic holography at each of a number m of wavelengths λₘ of light are made to determine the phase of light scattered from an object and received at an image receiver such as film, or an electronic CMOS or CCD array detector. FIG. 1 shows a prior art interferometric imaging diagram. A light source 10 produces coherent light output which is converted into a parallel light beam 12 by a lens 11. The beam 12 is split by a beamsplitter 13 into two parts, one part which illuminates an object 15, the other part which illuminates a reference surface 14. The reference surface 14 may be a specularly reflecting surface, a diffusely scattering surface, or any combination of the two. Light scattered from the reference surface 14 and the object 15 is combined at the beamsplitter 13 and propagates to the lens 16, which images both the surface of the object 15 and the surface of the reference surface 14 on to an image detector 17. Preferably, an image is exposed, and the reference surface 14 in the reference beam is moved to change the relative phase of the reference beam with respect to the object beam measured at the image receiver. Each image recorded for each relative phase difference is called a phase image. Preferably, a number n phase images are exposed. The wavelength of the light source 10 is then changed, and the process repeated for m wavelengths.

A problem with the prior art is that phase changes in the reference arm of the interferometer are not set accurately enough due to time lags in moving mechanical parts and hysteresis in the piezo drivers for moving the reference phase surface. If the wavelength of the laser used to expose the interferograms is changed, it will not be set accurately enough for the same reason. For the number of images required for accurate surface measurement, the sum of time lags in setting phase and frequency of the light source 10 can be much greater than the exposure times or the time needed to process the image information to make a surface map of the object.

U.S. Pat. No. 7,440,114 by Klooster , et al. entitled “Off-axis paraboloid interferometric mirror with off focus illumination” issued Oct. 21, 2008 describes a multiwavelength interferometric imaging system with a number of improvements over the basic system shown in FIG. 1. Optical fibers are used to carry light from light source 10 to points where the object and the image receiver are illuminated. Optical fiber techniques speed up the changes in relative phase of the object and reference beams.

FIG. 2 shows the tunable coherent light source 10 of the invention. Light 20 from a tunable diode laser 22 operating in the IR spectral region is directed into a non linear frequency converting device 24 which converts the light 20 to a shorter wavelength light 26 in the visible or near IR spectral region which can be detected by a silicon CDD or CMOS image receiver. These devices are not sensitive to light having wavelength longer than about 1100 nm. Image receivers which can detect light wavelengths longer than 1100 nm are expensive and have much less resolution than the silicon devices. Tunable diode IR lasers are used in the 1300 and 1550 nm bands for communications through optical fibers. These lasers are commercially available, reliable, and much cheaper than tunable lasers in the visible and near IR spectral region.

Preferable non linear frequency conversion devices are frequency doublers, triplers, frequency subtraction devices, and other parametric frequency conversion devices. In the art of frequency conversion, a non linear conversion device is a device whose output converted power is a non linear function of the input power in a particular power region. Such devices are preferably crystals lacking a center of symmetry for frequency doubling. One type of crystal commonly used has a different index of refraction for different polarizations of the light. The second harmonic must be in phase with the first harmonic over the length of the crystal for efficient conversion, and the orientation of the crystal is chosen so that the first and second harmonic have opposite polarizations and are phased matched over the length of the crystal. For a tunable input laser beam, such crystals are generally phase matched by changing temperature and/or angle of the crystal to the incoming light beam. When changing the input frequency, the crystal has a relatively narrow wavelength output band before the temperature or angle must be changed. Such changes are too slow to allow for the rapid acquisition of the number of images needed for multiwavelength interferometric imaging. If a frequency doubling crystal is not phase matched, the first harmonic will convert to the second harmonic for a length called a coherence length, and then the generated second harmonic will convert back to the first harmonic. The second harmonic power in the crystal will be a sinusoidal function of the distance traveled.

Another method of frequency doubling is the use of poled crystals, where the symmetry of the crystal is changed periodically by changing the domain structure. Then, when the doubled frequency power starts to convert back to the first harmonic, the changed crystal symmetry allows the second harmonic power to build up once again. The crystal has many such regions and the second harmonic can build up. The conversion efficiency is determined by the number of such poled regions. The bandwidth of conversion is relatively narrow. Preferred crystals are ferroelectric crystals where the poling is controlled by electric fields in the crystal.

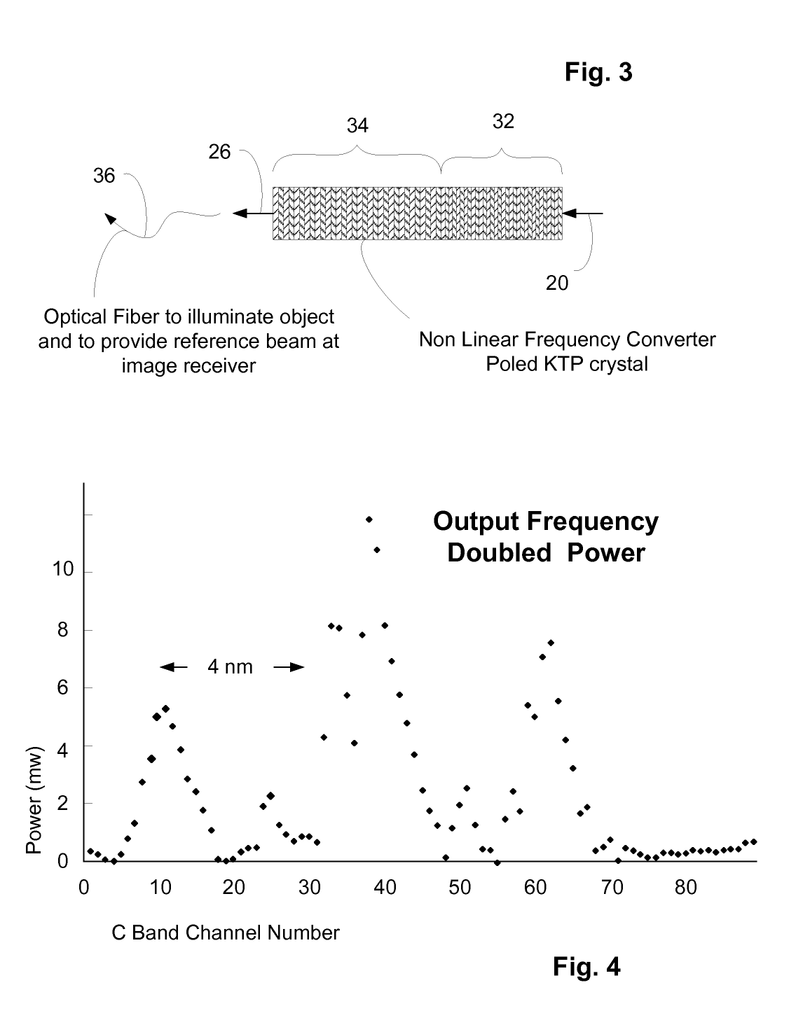

FIG. 3 shows a preferred embodiment of the invention. A first region 32 of the crystal is poled by one of several techniques know in the art so that efficient conversion for one spectral region is obtained. Then, the poling period is changed in a second region 34. Second harmonic light generated in the first region is little affected by the second, as there is no phase matching. However, if the frequency of the input light 20 is changed, little second harmonic light will be generated in the first region 32, but the second region 34 will be phase matched. Thus, the non-linear frequency doubler of FIG. 3 will be able to convert light in two spectral bands.

More than two different poling regions are most preferred for the invention.

FIG. 4 shows the measured output second harmonic power as a function of C band laser channel generated by a poled KTP crystal having 4 different periodic poling regions. Note that there are 17 output wavelengths with over 5 mw power distributed over a 15 nm band near 775 nm. The frequency difference between neighboring C band channels is 50 GHz, which would give a depth of field of =/−0.75 mm for resolving height differences on the object surface. The inventors anticipate that this depth of field may be expanded by using subband tuning of the communication lasers to give a set of frequencies spaced closer than 50 GHz apart.

The wavelength region accessible to this technique may be extended using even more poling regions and by concatenating two or more lasers 22. An article describing such a combination of communication band lasers by Brandon George and Dennis Derickson may be found at Proc. of SPIE Vol. 7554 75542O-pp 1-8 (2010) and on the web at

http://digitalcommons.calpoly.edu/cgi/viewcontent.cgi?article=1176&context=eeng_fac

The above articles reports usable output spanning the C and L communication bands from 1523 to 1610 nm, which when frequency doubled would give near IR light from 760 to 805 nm.

The above identified publications and reports are hereby incorporated herein by reference in their entirety including incorporated material.

Obviously, many modifications and variations of the present invention are possible in light of the above teachings. It is therefore to be understood that, within the scope of the appended claims, the invention may be practiced otherwise than as specifically described.

We claim:

1. An apparatus, comprising;
a multiwavelength holographic imaging apparatus for multiwavelength holographic imaging a surface of an object on to an image receiver,
wherein the holographic imaging apparatus comprises a generator of wavelength tunable coherent light of wavelength tunable around a wavelength λ₁, wherein the image receiver is sensitive to light having wavelength around λ₁;
wherein the generator of coherent light comprises a frequency converter for converting input tunable coherent light having a wavelength tunable around a wavelength λ₂ to output tunable coherent light having a wavelength tunable around a wavelength λ₁.

2. The apparatus of claim 1, wherein the frequency converter is a non-linear frequency converting element.

3. The apparatus of claim 2, wherein the frequency converter is a frequency doubler.

4. The apparatus of claim 3, wherein the frequency converter converts input light from a tunable diode laser having wavelength tunable over a wavelength region near 1550 nanometers to tunable output light having wavelength near 775 nm.

5. The apparatus of claim 3, wherein the frequency doubler is a poled non-linear crystal.

6. The apparatus of claim 4, wherein the frequency doubler is a poled non-linear crystal having at least two poled regions, each of the at least two poled regions having a different poling period.

7. The apparatus of claim 6, wherein the frequency doubler is a poled non-linear crystal having more than two poled regions, each of the more than two poled regions having a different poling period.

8. The apparatus of claim 1, wherein the frequency converter converts tunable input light from a tunable diode laser to coherent light of wavelength tunable around a wavelength λ₁.

9. The apparatus of claim 8, wherein the frequency converter converts input light from the tunable laser diode to light tunable over a wavelength region of δλ>10 nanometers in a wavelength region near 775 nm.

10. The apparatus of claim 8, wherein the frequency converter converts input light from the tunable laser diode to output light tunable over at least two wavelength regions within a bandwidth of δλ=15 nanometers around wavelength region near 775 nanometers.

11. The apparatus of claim 8, wherein the frequency converter is a frequency doubler.

12. The apparatus of claim 11, wherein the frequency doubler converts input light from the tunable laser diode to output tunable light which is continuously tunable over more than one separated bandwidth regions within a bandwidth region of δλ=15 nanometers.

13. The apparatus of claim 12, wherein the frequency doubler is a poled non-linear crystal having at least two poled regions, each region having a different poling period.

14. An apparatus, comprising;
a multiwavelength holographic imaging apparatus for multiwavelength holographic imaging a surface of an object on to an image receiver,
wherein the holographic imaging apparatus comprises a generator of wavelength tunable coherent light of wavelength tunable around a wavelength λ₁, wherein the image receiver is sensitive to light of wavelength λ₁;
wherein the generator of coherent light comprises a frequency converter for converting input tunable coherent light having a wavelength tunable around a wavelength λ₂ to output tunable coherent light of wavelength λ₁, wherein a first part of the tunable coherent light of wavelength λ₁ is communicated by a first optical system to the surface of the object, and wherein the tunable coherent light of wavelength λ₁ scattered by the surface of the object is imaged on to the surface of the image receiver by an imaging system, and
wherein a second part of the tunable coherent light of wavelength λ₁ is communicated by an optical system to the image receiver to produce interference between the first and second parts of the tunable coherent light of wavelength λ₁ at the image receiver.

15. The apparatus of claim 14, wherein the frequency converter is a frequency doubling crystal having at least two poled regions, each region having a different poling period.

16. The apparatus of claim 15, wherein the frequency doubler is a poled non-linear crystal having more than two poled regions, each of the more than two poled regions having a different poling period.

17. The apparatus of claim 16, wherein the frequency converter converts input light from the tunable laser diode to output light tunable over at least two wavelength regions within a bandwidth of δλ=15 nanometers around wavelength region near 775 nanometers.
